(19) United States
(12) Patent Application Publication
(10) Pub. No.: US 2025/0031131 A1
(43) Pub. Date: Jan. 23, 2025

(54) APPARATUS, METHODS, AND COMPUTER PROGRAMS

(71) Applicant: Nokia Technologies Oy, Espoo (FI)

(72) Inventor: Jens GEBERT, Ulm (DE)

(21) Appl. No.: 18/573,426

(22) PCT Filed: Jun. 22, 2021
(86) PCT No.: PCT/EP2021/066956

§ 371 Date: Dec. 21, 2023

(51) Int. Cl. H04W 48/08; H04L 41/5051

(52) U.S. Cl. CPC H04W 48/08; H04L 41/5051

(57) ABSTRACT

There is provided a method for, a computer program for, an apparatus for a network repository function, for causing the following operations to be performed: receiving, from a first network function, a first indication of whether the first network function is located in a radio access network; and in response to receiving a request for information about the first network function from a second network function, signalling to the second network function a second indication of whether the first network function is located in the radio access network.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE). Another example communication system is so called 5G system that allows user equipment (UE) or user device to contact a 5G core via e.g. new radio (NR) access technology or via other access technology such as Untrusted access to 5GC or wireline access technology.

### SUMMARY

According to a first aspect, there is provided an apparatus for a network repository function, the apparatus comprising: at least one processor; and at least one memory comprising code that, when executed by the at least one processor, causes the apparatus to: receive, from a first network function, a first indication of whether the first network function is located in a radio access network; and in response to receiving a request for information about the first network function from a second network function, signalling to the second network function a second indication of whether the first network function is located in the radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a second aspect, there is provided an apparatus for a second network function, the apparatus comprising: at least one processor; and at least one memory comprising code that, when executed by the at least one processor, causes the apparatus to: signal, to a network repository function, a request for information about a first network function; in response to said signalling, receiving, from the network repository function, a second indication of whether the first network function is located in the radio access network; and signal, to the first network function, a request for service in response to the second indication.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a third aspect, there is provided an apparatus for a first network function, the apparatus comprising: at least one processor; and at least one memory comprising code that, when executed by the at least one processor, causes the apparatus to: signal, to a network repository function, a first indication of whether the first network function is located in a radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

According to a fourth aspect, there is provided an apparatus for a network repository function, the apparatus comprising: means for receiving, from a first network function, a first indication of whether the first network function is located in a radio access network; and means for signalling to the second network function, in response to receiving a request for information about the first network function from a second network function, a second indication of whether the first network function is located in the radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a fifth aspect, there is provided an apparatus for a second network function, the apparatus comprising: means for signalling, to a network repository function, a request for information about a first network function; means for receiving from the network repository function, in response to said signalling, a second indication of whether the first network function is located in the radio access network; and means for signalling, to the first network function, a request for service in response to the second indication.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a sixth aspect, there is provided an apparatus for a first network function, the apparatus comprising: means for signalling, to a network repository function, a first indication of whether the first network function is located in a radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

According to a seventh aspect, there is provided a method for an apparatus for a network repository function, the method comprising: receiving, from a first network function, a first indication of whether the first network function is located in a radio access network; and signalling to the second network function, in response to receiving a request for information about the first network function from a second network function, a second indication of whether the first network function is located in the radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to an eighth aspect, there is provided a method for an apparatus for a second network function, the method comprising: signalling, to a network repository function, a request for information about a first network function; receiving from the network repository function, in response to said signalling, a second indication of whether the first network function is located in the radio access network; and signalling, to the first network function, a request for service in response to the second indication.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a ninth aspect, there is provided a method for an apparatus for a first network function, the method comprising: signalling, to a network repository function, a first indication of whether the first network function is located in a radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

According to a tenth aspect, there is provided an apparatus for a network repository function, the apparatus comprising: receiving circuitry for receiving, from a first network function, a first indication of whether the first network function is located in a radio access network; and signalling circuitry for signalling to the second network function, in response to receiving a request for information about the first network function from a second network function, a second indication of whether the first network function is located in the radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to an eleventh aspect, there is provided an apparatus for a second network function, the apparatus comprising: signalling circuitry for signalling, to a network repository function, a request for information about a first network function; receiving circuitry for receiving from the network repository function, in response to said signalling, a second indication of whether the first network function is located in the radio access network; and signalling circuitry for signalling, to the first network function, a request for service in response to the second indication.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a twelfth aspect, there is provided an apparatus for a first network function, the apparatus comprising: signalling circuitry for signalling, to a network repository function, a first indication of whether the first network function is located in a radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

According to a thirteenth aspect, there is provided non-transitory computer readable medium comprising program instructions for causing an apparatus for a network repository function to perform at least the following: receive, from a first network function, a first indication of whether the first network function is located in a radio access network; and in response to receiving a request for information about the first network function from a second network function, signalling to the second network function a second indication of whether the first network function is located in the radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a fourteenth aspect, there is provided non-transitory computer readable medium comprising program instructions for causing an apparatus for a second network function to perform at least the following: signal, to a network repository function, a request for information about a first network function; in response to said signalling, receiving, from the network repository function, a second indication of whether the first network function is located in the radio access network; and signal, to the first network function, a request for service in response to the second indication.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The request for information may comprise a discovery request for a network function that is local to a service consumer.

According to a fifteenth aspect, there is provided non-transitory computer readable medium comprising program instructions for causing an apparatus for a first network function to perform at least the following: signal, to a network repository function, a first indication of whether the first network function is located in a radio access network.

The first indication may be signalled with a third indication of whether the first network function is mobile.

The first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

According to a sixteenth aspect, there is provided a computer program comprising program instructions for causing a computer to perform any method as described above.

According to a seventeenth aspect, there is provided a computer program product stored on a medium that may cause an apparatus to perform any method as described herein.

According to an eighteenth aspect, there is provided an electronic device that may comprise apparatus as described herein.

According to a nineteenth aspect, there is provided a chipset that may comprise an apparatus as described herein.

### BRIEF DESCRIPTION OF FIGURES

Examples will now be described, by way of example only, with reference to the accompanying Figures in which:

FIG. 1 shows a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of an example network structure;

FIG. 6 shows a schematic representation of an example network structure;

FIGS. 7 and 8 illustrate example use cases;

FIGS. 9 to 16 illustrate example signalling operations; and

FIGS. 17 to 19 are flow charts illustrating potential operations that may be performed by apparatus described herein.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, current 6G proposals). In the following, 3GPP refers to a group of organizations that develop and release different standardized communication protocols. 3GPP is currently developing and publishing documents related to Release 16, relating to 5G technology, with Release 17 currently being scheduled for 2022.

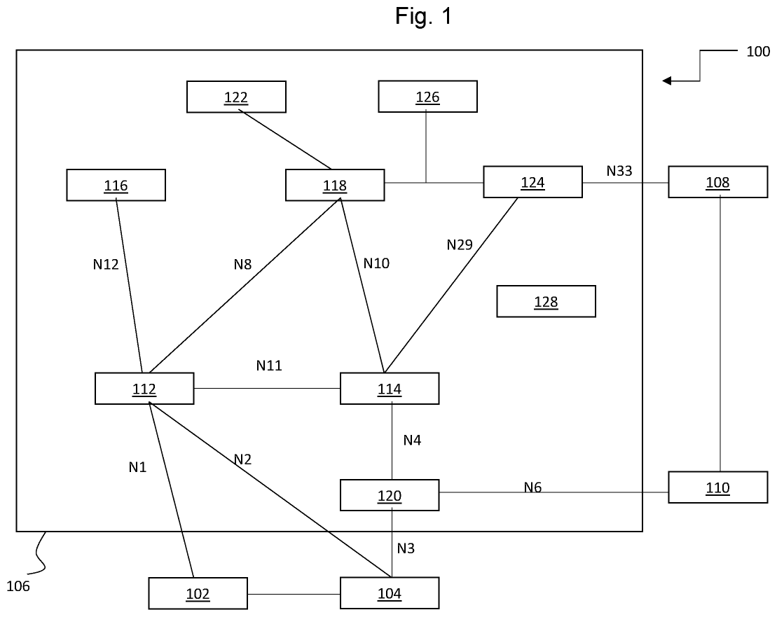

Before explaining in detail the exemplifying embodiments, certain general principles of a 5G wireless communication system are briefly explained with reference to FIG. 1.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes. It is understood that although the example network element is shown as a single apparatus, that the functions of the network element may be split amongst several distinct apparatuses.

The 5GC 106 may comprise one or more network functions, including one or more Access Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. Although the NRF 128 is not depicted with its interfaces, it is understood that this is for clarity reasons and that NRF 128 may have a plurality of interfaces with other network functions. It is understood that although the example network functions are respectively shown as a single apparatus, that the functions of each network function may be split amongst several distinct apparatuses.

The NRF performs multiple functions for the 5GC 106. For example, the NRF is configured to maintain a network function (NF) profile of available NF instances and their supported services, where an NF instance identifier represents an identifier identifying a particular NF/NF instance. The NF instance identifier is provided by the NF service consumer (i.e. a network function that is requesting a service from another entity, such as an NF service producer), and is globally unique inside the Public landline Mobile Network of the NRF in which the NF is registered. The NRF is also configured to allow other NF instances to subscribe to, and get notified about, the registration in NRF of new NF instances of a given type. The NRF is further configured to support service discovery functions by receiving NF Discovery Requests from NF instances, and provide information in respect of available NF instances fulfilling certain criteria (e.g., supporting a given service) in response to those NF Discovery Requests.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

3GPP refers to a group of organizations that develop and release different standardized communication protocols. They are currently developing and publishing documents related to Release 16, relating to 5G technology, with Release 17 currently being scheduled for 2022.

The 5G standards introduced a new architectural concept into 3GPP communication networks called the Service Based Architecture (SBA). Using this architecture, Network Functions (NFs) can be virtualized and provide their services, using defined protocols and interfaces to other network functions or external parties' “verticals” (e.g. industrial application such as transport, media, and manufacturing). The interfaces are referred to as service-based interfaces (SBI), and may comprise REST Application Protocol Interface (API)-based interfaces, where REST is an existing defined protocol. The protocols for communication between the network elements may be, for example, the common HTTP/2 Internet protocol, where HTTP/2 is an update to the Hypertext Transfer Protocol (HTTP). Entities that provide a service are called “service producers” and entities requesting a service are called “service consumers”. Communication procedures under 5G System Architecture are specified in 3GPP TS 23.501 and 3GPP TS 23.502.

The 5G System Architecture is defined to support the NF Service Framework that enables the use of NF services. The NF Service Framework includes a plurality of different mechanisms. These are discussed further below.

As a first example, the NF Service Framework supports NF Discovery and Selection. In particular, NFs register the services they provide with an NRF, and keep reporting their status to the NRF. NF service consumers may then discover NF service producers through NRF, and select a proper one according to NF selection logic.

3GPP TS 23.501 describes how the NF discovery and selection are done in the current SBA. Under this SBA, different NF types may have different discovery and selection logic depending on their produced services, configuration and some dynamic information (such as, for example, load statistics). In general, an NF consumer will receive a list of NF producers from the NRF through the discovery procedure and select one of those NF producers to which to send the service request.

As discussed above, the NRF is a component in the 5G Service Based Architecture that supports service discovery, maintains the Network Function (NF) profile of available NF instances and their supported services and notifies about newly registered, updated, and deregistered NF instances along with its NF services to the subscribed NF service consumer.

Currently, the Service Based Architecture is only used in the Core Network (CN) and not in the (Radio) Access Network ((R)AN).

However, in some deployment options, NFs belonging logically to the CN can be placed inside a node in the RAN. This may be, for example, for reasons of performance optimization.

When placing an NF inside the RAN, some restrictions, some special conditions, and/or new features may apply. This following focusses on providing additional information to the NRF about an NF placed inside the (R)AN towards the NRF. The NRF may then provide such information to other users of the NRF. This may be useful, for example, when an NF is placed inside a relay node, which may be mobile. Such relaying nodes are specified for 3GPP Rel. 16 in the framework of Integrated Access and Backhaul (IAB) as IAB-nodes.

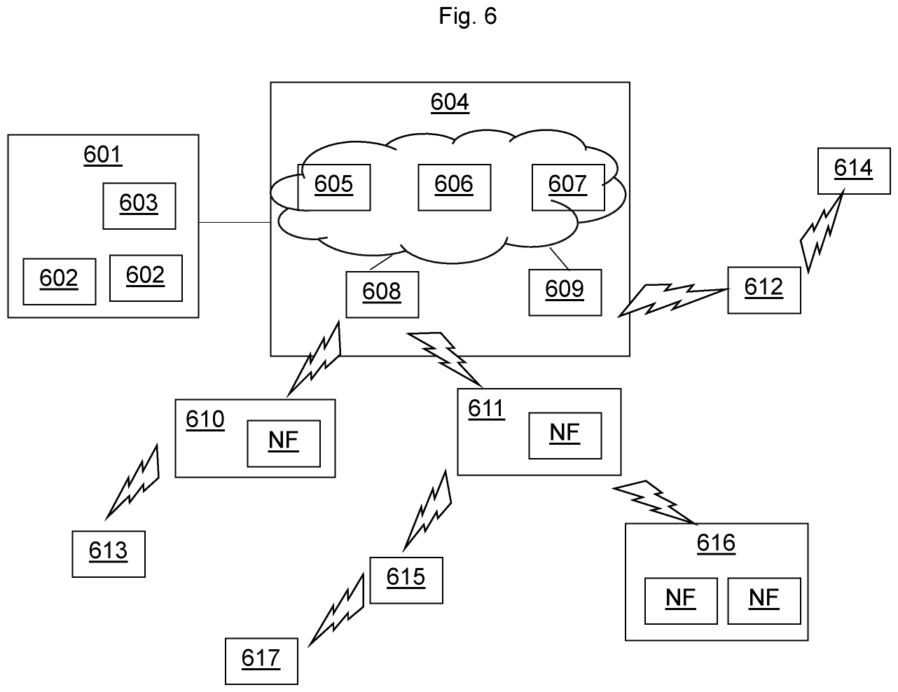

FIG. 6 is a schematic illustration of an example network architecture.

FIG. 6 shows a core network 601 comprising a plurality of network functions 602 and an NRF 603. The core network 601 may connect to a gNB 604. In the 5G network, the gNB base station provides NR protocol terminations to the user equipment (UE) and is connected to the 5G Core (5GC) network. As defined in 3GPP TS 38.401, the gNB is a logical node, which may be split into one central unit (CU) and one or more distributed units (DU). The CU hosts the higher layer protocols to the UE and terminates the control plane and user plane interfaces to the 5GC. The CU controls the DU nodes over respective F1 interface(s), where the DU node hosts the lower layers for the new radio interface to the UE (Uu). The gNB in the present example comprises a control plane CU 605 and a user plane CU 606 that are connected to network functions 607. The gNB in the present example further comprises a first DU 608 and a second DU 609 comprising a network function. The first and second DUs may be connected to the CUs via a wireline connection.

The first DU 608 is depicted as communicating with a first IAB node 610 and a second IAB node 611, each of these IAB nodes comprising a respective network function (labelled as NF). The second DU is depicted as communicating with a third IAB node 612 that does not comprise a respective network function. The IAB nodes communicate with their associated DUs over respective wireless backhaul links. It is understood that these examples are not limiting, and that any IAB node (such as, for example, IAB nodes 610, 611) may comprise at least one of an IAB-Mobile Termination part and an IAB-DU part.

The first and third IAB nodes are shown as communicating with respective first and third UEs 613, 614. The second IAB node 611 is shown as communicating with a fourth IAB node 615 that does not comprise a network function, and a fifth IAB node 616 that comprises a plurality of network functions. The fourth IAB node 615 is shown as communicating with a second UE 617.

The NF profile hosted in the NRF does currently not store any information related to the fact that a NF may be located in the RAN, e.g. inside an IAB-node, such as the first, second, and fifth IABs discussed above. This means, there is currently no knowledge in the 5G System (5GS) that a NF function may be behind a radio link, and/or may be mobile.

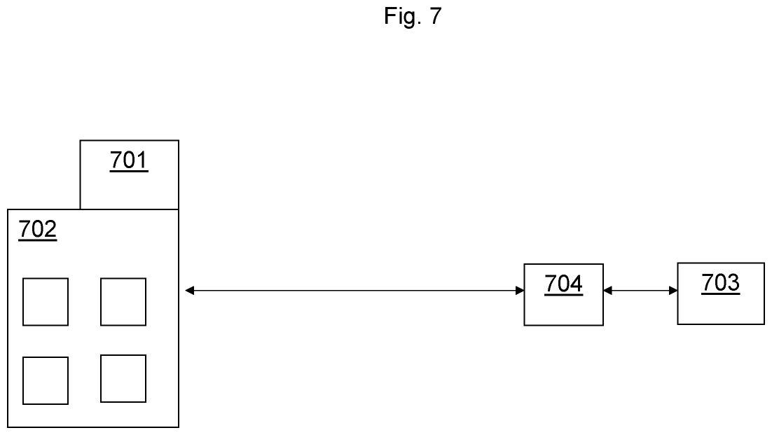

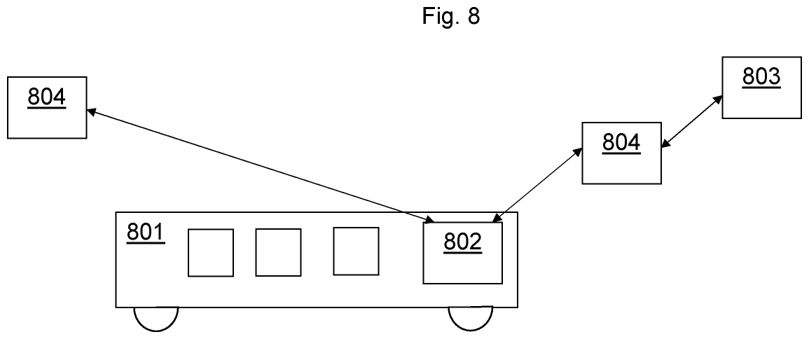

FIGS. 7 and 8 illustrate practical examples in which an NF is located in the RAN.

FIG. 7 illustrates a practical example for local traffic in which a local user plane function is located inside an IAB node 701 located on a building 702. The IAB node 701 provides network access to a plurality of users in the building 702. The IAB node 701 communicates with a network 703 via an IAB donor node 704 (e.g. a gNB).

The users in the building may use a local service provided by the IAB node 701, with the IAB node 701 providing performance optimisation as local UPF (instead of using a UPF in the core network). This reduces the user plane traffic on the backhaul interface e.g. between the IAB-node and the IAB donor gNB.

FIG. 8 illustrates an example in which a vehicle 801 comprises an IAB 802 comprising a UPF. The IAB node 802 provides network access to a plurality of users in the vehicle 801. The IAB node 802 communicates with a network 803 via at least one IAB donor node 804. As the vehicle (and consequently the IAB node 802) moves, the IAB changes the IAB donor node 804 with which it connects to network 803 in order to optimize performance/signal strength.

In these examples of FIGS. 7 and 8, the NF provided in the RAN is a UPF. It is understood that UPF is not a typical NF as the UPF is on the user plane and not on the control plane. However, as the UPF can register to the NRF, it may still be considered as a NF for the purposes of the presently described techniques. It is further understood that the present techniques may also apply in respect of network functions that are located in the core network.

The NRF already stores a large amount of information in the NFProfile. For example, the NRF comprises information on an NF's serving scope, which indicates geographical areas served by the associated NF. The serving scope may be used to, for example, discover and select NFs in centralized data centres that are expected to serve users located in specific region(s) and/or province(s). As another example, the NEF comprises information on the operator-defined location of NF instances, such as, for example, geographic location, data centre, etc.

Examples of the current information provided in an NF profile is indicated in Table 1 below, which replicates information from the NFProfile currently defined in 3GPP TS 29.510.

TABLE 1
NF profile information

| Attribute name | Data type | P | Cardinality | Description |
|---|---|---|---|---|
| nfInstanceId | NfInstanceId | M | 1 | Unique identity of the NF Instance. |
| nfType | NFType | M | 1 | Type of Network Function |
| nfStatus | NFStatus | M | 1 | Status of the NF Instance |
| nfInstanceName | string | O | 0 . . . 1 | Human readable name of the NF |
| | | | | Instance |
| plmnList | array(PlmnId) | C | 1 . . . N | PLMN(s) of the Network Function |
| | | | | (NOTE 5). This IE shall be present if this |
| | | | | information is available for the NF. If this |
| | | | | information was not provided by the NF |
| | | | | during registration, the NRF should |
| | | | | return the list of PLMN ID(s) of the |
| | | | | PLMN of the NRF. If this IE is absent in |
| | | | | the response, PLMN ID(s) of the PLMN |
| | | | | of the NRF are assumed for the NF. |
| sNssais | array(Snssai) | O | 1 . . . N | Single - Network Slice Selection |
| | | | | Assistance Informations (S-NSSAIs) of |
| | | | | the Network Function. |
| | | | | If not provided, the NF can serve any S- |
| | | | | NSSAI. |
| | | | | If the sNssais attribute is provided in at |
| | | | | least one NF Service, the sNssais |
| | | | | attribute in the NF Profile is present and |
| | | | | is the set or a superset of the sNSSAIs |
| | | | | of the NFService(s). |
| nsiList | array(string) | O | 1 . . . N | List of NSIs of the Network Function. |
| | | | | If not provided, the NF can serve any |
| | | | | NSI. |
| fqdn | Fqdn | C | 0 . . . 1 | Fully Qualified Domain Name (FQDN) of |
| | | | | the Network Function |
| ipv4Addresses | array(Ipv4Addr) | C | 1 . . . N | IPv4 address(es) of the Network |
| | | | | Function |
| ipv6Addresses | array(Ipv6Addr) | C | 1 . . . N | IPV6 address(es) of the Network |
| | | | | Function |
| capacity | integer | O | 0 . . . 1 | Static capacity information within the |
| | | | | range 0 to 65535, expressed as a weight |
| | | | | relative to other NF instances of the |
| | | | | same type; if capacity is also present in |
| | | | | the nfServiceList parameters, those will |
| | | | | have precedence over this value. |
| load | integer | O | 0 . . . 1 | Latest known load information of the NF |
| | | | | within the range 0 to 100 in percentage |
| . . . | | | | |
| locality | string | O | 0 . . . 1 | Operator defined information about the |
| | | | | location of the NF instance (e.g. |
| | | | | geographic location, data center) |
| . . . | | | | |
| servingScope | array(string) | O | 1 . . . N | The served area(s) of the NF instance. |
| | | | | The absence of this attribute does not |
| | | | | imply the NF instance can serve every |
| | | | | area. (NOTE 13) |

(NOTE 13):
The servingScope attribute may indicate geographical areas, It may be used e.g. to discover and select NFs in centralized Data Centers that are expected to serve users located in specific region(s) or province(s). It may also be used to reduce the large configuration of Tracking Area Identifiers (TAIs) in the NF instances.

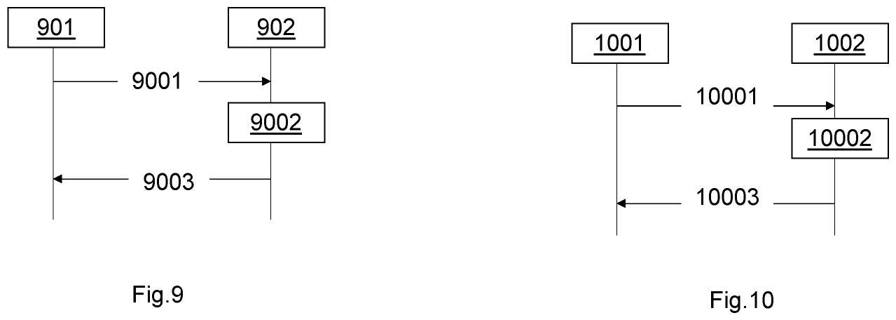

The NRF receives information for storing during an NF Instance Registration to NRF and during an NF Partial Profile Update. These operations are discussed below with reference to FIGS. 9A and 9B.

FIG. 9 illustrates signalling between an NF service consumer (i.e. a NF that requests a service from another NF) 901 and an NRF 902.

At 9001, the NF service consumer 901 sends a registration request to the NRF 902 for registering information about the NF service consumer 901 at the NRF. This registration request may be sent in any of a plurality of different forms. For example, the request may be sent as a defined 3GPP registration request for the network function 901 (such as the request labelled “Nnrf_NFManagement_NFRegister_Request” in 3GPP specifications). The request may be sent using HTTP signalling (such as, for example, the request labelled “PUT . . . /nf-instances/{nfinstanceID} (NFProfile)” in 3GPP specifications).

At 9002, the NRF 902 stores an NF profile corresponding to that requested in 9001 in response to the signalling of 9001.

At 9003, the NRF responds to the signalling of 9001 to indicate that the NF profile has been stored. This indication may be sent in any of a plurality of different forms. For example, the indication may be sent as a defined 3GPP registration request response for the network function 901 (such as the indication labelled “Nnrf_NFManagement_NFRegister_Response” in 3GPP specifications). The indication may be sent using HTTP signalling (such as, for example, the indication labelled “201 Created (NFProfile)” in 3GPP specifications).

FIG. 10 illustrates signalling between an NF service consumer 1001 and an NRF 1002 during an NF Service Update Procedure and/or an NF Partial Profile Update Procedure.

At 10001, the NF service consumer 1001 sends an update request to the NRF 1002 for updating information about the NF service consumer 1001 at the NRF. This update request may be sent in any of a plurality of different forms. For example, the request may be sent as a defined 3GPP update request for the network function 1001 (such as the request labelled “Nnrf_NFManagement_NFUpdate_Request” in 3GPP specifications). The request may be sent using HTTP signalling (such as, for example, the request labelled “PATCH . . . /nf-instances/{nfinstanceID} (PatchData)” in 3GPP specifications).

At 10002, the NRF 1002 updates information stored in an NF profile corresponding to that of the update request in 10001 in response to the signalling of 10001.

At 10003, the NRF 1002 responds to the signalling of 10001 to indicate that the NF profile has been updated. This indication may be sent in any of a plurality of different forms. For example, the indication may be sent as a defined 3GPP registration request for the network function 1001 (such as the indication labelled “Nnrf_NFManagement_NFUpdate_Response” in 3GPP specifications). The indication may be sent using HTTP signalling (such as, for example, the indication labelled “200 OK (NFProfile)” in 3GPP specifications, or “4xx/5xx (Problem Details) when the update operation of 10002 failed).

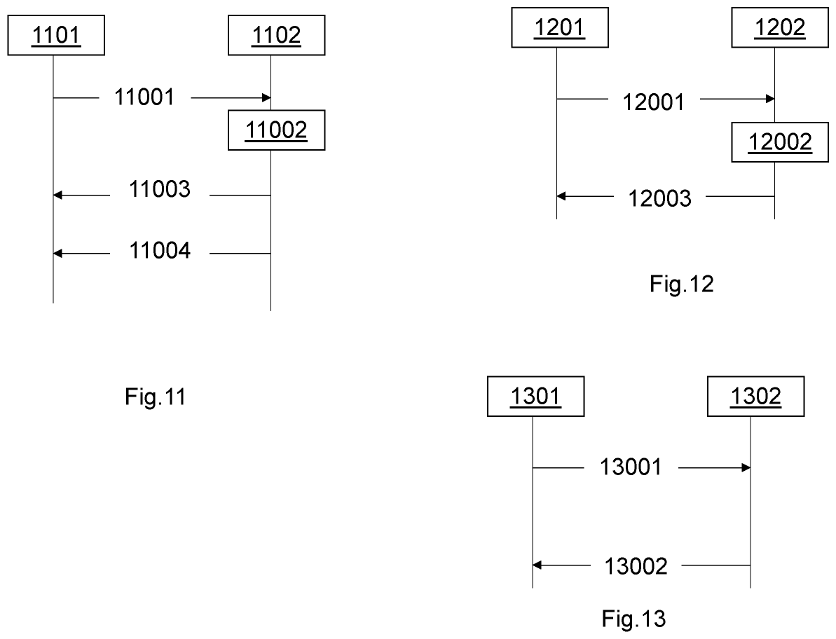

Other NFs (NF Service Consumer) may subscribe to the NRF to be notified when NF Instances of a given set, following certain filter criteria, are registered/deregistered in NRF or when their profile is modified. If such a registration/deregistration/profile modification event occurs, a notification including the Notification Data is sent from the NRF to the NF Service Consumer. This is illustrated with respect to FIG. 11.

FIG. 11 illustrates signalling that may be performed between an NF service consumer 1101 and an NRF 1102 in relation to subscription requests.

At 11001, the NF service consumer 1101 sends a subscription request to the NRF 1102 to be notified when the NRF profile information for at least one requested NF changes. This request is currently labelled as “Nnrf_NFManagement_NFStatusSubscribe Request” in 3GPP specifications. When HTTP used to signal this subscription request, this request is labelled as “POST . . . /subscriptions(SubscriptionData)”.

At 11002, the NRF 1102 authorises the subscription request of 1101.

At 11003, the NRF 1102 signals a response to the NF service consumer in response to the signalling of 11001. This request is currently labelled as “Nnrf_NFManagement_NFStatusSubscribe Response” in 3GPP specifications. When HTTP used to signal this response, this response is labelled as “201 Created (SubscriptionData)” when a subscription is created. If a subscription is not created/authorized in 11002, the NRF 1102 may signal an error message in response to the subscription request in 11001. This error message may indicate a reason why the subscription was not created/authorized. When HTTP used to signal this error message, this may be labelled as “4xx/5xx (ProblemDetails)”.

At 11004, the NRF 1102 signals a notification to the NF service consumer 1101 that a change has occurred in a profile associated with an NF that is a subject of the subscription request of 11001. When HTTP used to signal this notification, this may be labelled as “POST (nfStatusNotificationUrl) (NotificationData)”. Although not shown in FIG. 11, the NF service consumer may respond to the signalling of 11004 when HTTP is used to acknowledge that the notification has been received (using, for example a “204 No Content( )” message), or by indicating that there has been a problem in receipt of the notification (e.g. using a “4xx/5xx (Problem Details)” message).

An NF service consumer that wants to use the service of another NF may use the NF Service discovery procedure to retrieve information from the NRF. This is described with respect to FIG. 12.

FIG. 12 illustrates signalling that may be performed between an NF service consumer 1201 and an NRF 1202.

At 12001, the NF service consumer 1201 sends a discovery request to the NRF 1202 for discovering a network function. This discovery request is currently labelled as “Nnrf_NFDiscovery_Request” in 3GPP specifications. When HTTP is used to signal this discovery request, this may be expressed as “GET . . . /nf-instances?<query parameters>”.

At 12002, the NRF 1202 authorises the NF service Discovery that is the subject of the request of 12001.

At 12003, the NRF 1202 signals a response to the NF service consumer 1201 in response to the signalling of 12001. When HTTP is used to signal the response and the discovery request has been successfully executed/authorized, this may be signalled using “200 OK (SearchResult). When HTTP is used to signal the response and the discovery request has not been successfully executed/authorized, this may be signalled using “4xx/5xx (Problem Details)”. In other words, when the discovery request of 12001 has been unsuccessful, the NRF 1202 may inform the NF service consumer 1201 of this lack of success, and provide a reason why.

The present disclosure may further relate to interactions between the SMF and the user plane function (UPF). The SMF and UPF interactions are currently described in 3GPP Technical Specification 23.502.

Besides session related procedures (e.g. N4 Session Establishment, N4 Session Modification, N4 Session Release, and N4 Session Reporting, where N4 relates to the interface between the UPF and the SMF), there are also N4 Node Level Procedures, such as the N4 Association Setup, N4 Association Update, N4 Association Release and N4 Reporting. The N4 association setup is described below in relation to FIG. 13.

FIG. 13 illustrates signalling that may be exchanged between an SMF 1301 and a UPF 1302 in order to setup an N1 association between the SMF 1301 and the UPF 1302. The N1 association is session independent and configures the SMF 1301 and the UPF 1302 to perform specified operations for maintaining the association, such as, for example, exchanging configuration data, reporting failures, reporting statistics for signalling, etc.

At 13001, the SMF 1301 sends an association request to the UPF 1302.

At 13002, the UPF 1302 sends a response to the signalling of 13001 to the SMF 1301.

It is understood that although the SMF is shown as initiating the N1 association setup in FIG. 13 that the UPF may instead signal the request of 13001 to the SMF, and the SMF may instead signal the response of 13002 in response to the signalling from the UPF.

The following relates to information that may be provided by NFs to the NRF for addressing issues that arise when an NF is located inside a RAN.

Co-locating a Core Network Function (e.g. an UPF) to a RAN Node is known in a plurality of different situations. For example, Local IP Access (LIPA) (currently described in 3GPP Technical Specification 23.401) enables a UE connected via a Home eNB (HeNB) to access other entities in the same residential/enterprise network. Further, Selected IP Traffic Offload (SIPTO) (currently described in 3GPP Technical Specification 23.401) enables an operator to offload certain types of traffic at a network node close to that UE's point of attachment to the access network. “SIPTO at the Local Network” can (as one of different options) be achieved by selecting a local Gateway function collocated with the (H)eNB.

To help address issues that crop up in such situations, in the following, an NF may provide an indication as to whether or not the NF is inside (or outside) a RAN. The NF may provide an indication as to whether or not the NF is behind a radio link and, if so, what the capabilities of the radio link are (e.g. bandwidth of the radio link). As another example, the NF may provide an indication as to whether or not the NF is mobile (i.e. whether or not the NF may change its point of attachment to the communication network). NF may provide an indication as which node (gNB/IAB node) the NF is located, including the type of node in which the NF is located. NF may provide an indication as to a path along which the NF can be reached (e.g. when there are several nodes through which signalling is traversed in order to reach the NF, and may include gNBs and/or IAB donors and/or IAB nodes). NF may provide an indication as to which area a NF can provide it's services, such as by providing a list of Cell identifiers.

The NRF may provide such information in the Service Discovery procedures and/or in the Notification procedures.

When changes occur in the network, such as, for example, as a result of mobility changes relating to IAB-node movement, and/or network reconfigurations (such as, for example IAB topology update), the NF may update the parameters at the NRF using at least one of an NF Service update or NF Profile Partial Update operation.

Similar parameters may be provided in the N4 Association Setup procedure in case of UPF-SMF interactions.

The following disclosure may thus be used to support mobile NFs, including NFs located in any RAN node, particularly also for NFs located in a Relay-node (IAB node). Therefore, there is disclosed support for NFs being at least one of behind a radio link, and mobile.

The NFProfile currently defined in 3GPP TS 29.510 (replicated above) may be enhanced with the additional parameters indicated in Tables 2 and 3 below.

TABLE 2
Extension to NF profile information

| Attribute name | Data type | P | Cardinality | Description |
|---|---|---|---|---|
| inAccessNetwork | InAccessNetworkInfo | O | 0 . . . 1 | Information if the NF is located inside |
| Info | | | | an access network and further |
| | | | | access related information |

TABLE 3
Potential parameters comprised and/or indicated by InAccessNetworkInfo of Table 2

| Attribute name | Data type | P | Cardinality | Description |
|---|---|---|---|---|
| inAccessNetwork | boolean | M | 1 | Indicates whether the NF is located |
| | | | | inside an Access Network |
| isMobile | boolean | O | 1 | Indicates whether the NF is mobile, i.e. |
| | | | | may change its point of attachment |
| accessLinkCharactersistics | accessLinkCharactersistics | O | 1 . . . N | Characteristics of the access link, e.g. |
| | | | | minmumDelay, maximum bandwidth |
| gNB name | PrintableString(SIZE(1 . . . 1 | O | | gNB name or, in case of decentralised |
| | 50, . . . )) | | | gNB, the gNB-CU name. |
| gNB-DU ID | INTEGER | O | | The gNB-DU ID is independently |
| | (0 . . . 2³⁶-1) | | | configured from cell identifiers, i.e. no |
| | | | | connection between gNB-DU ID and cell |
| | | | | identifiers. |

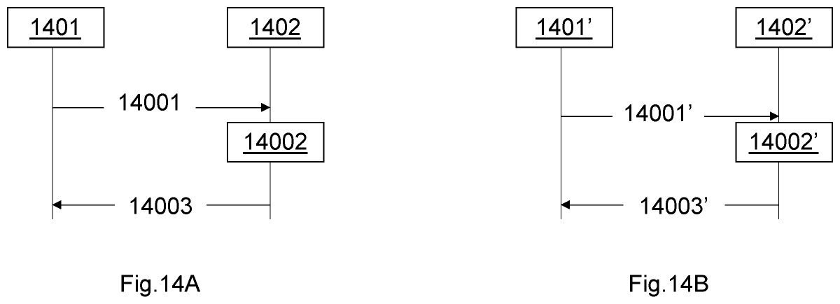

FIG. 14A is a signalling diagram illustrating signalling between an NF service consumer (i.e. a NF that requests a service from another NF) 1401 and an NRF 1402.

At 14001, the NF service consumer 1401 sends a registration request to the NRF 1402 for registering information about the NF service consumer 1401 at the NRF. This registration request may be sent in any of a plurality of different forms. For example, the request may be sent as a defined 3GPP registration request for the network function 1401 (such as the request labelled “Nnrf_NFManagement_NFRegister_Request” in 3GPP specifications). The request may be sent using HTTP signalling (such as, for example, the request labelled “PUT . . . /nf-instances/{nfinstanceID} (NFProfile)” in 3GPP specifications).

The request may indicate whether the NF is located inside (or outside) a RAN. Additionally or alternatively, the request may indicate whether the NF is mobile.

The request may comprise at least one of the parameters indicated above as being potentially provided/indicated as part of the InAccessNetworkInfo parameter. For example, the request may indicate at least one of: whether the registering NF is located inside a RAN, whether the registering NF is mobile, at least one performance characteristic of the access link to the NF, an access point name, geographic region(s) in which the registering NF may provide and/or receive a service, and/or a DU identifier.

At 14002, the NRF 1402 stores an NF profile corresponding to that requested in 14001 in response to the signalling of 14001.

At 14003, the NRF responds to the signalling of 14001 to indicate that the NF profile has been stored. This indication may be sent in any of a plurality of different forms. For example, the indication may be sent as a defined 3GPP registration request response for the network function 1401 (such as the indication labelled “Nnrf_NFManagement_NFRegister_Response” in 3GPP specifications). The indication may be sent using HTTP signalling (such as, for example, the indication labelled “201 Created (NFProfile)” in 3GPP specifications).

FIG. 14B illustrates signalling between an NF service consumer 1401′ and an NRF 1402′ relating to a notification to an NF service consumer when an NF profile has changed.

At 14001′, the NF service consumer 1401′ sends an update request to the NRF 1402′ for updating information about the NF service consumer 1401′ at the NRF. This update request may be sent in any of a plurality of different forms. For example, the request may be sent as a defined 3GPP update request for the network function 1401′ (such as the request labelled “Nnrf_NFManagement_NFUpdate_Request” in 3GPP specifications). The request may be sent using HTTP signalling (such as, for example, the request labelled “POST . . . {nfStatusNotificationUri} (NotificationData: REGISTRATION; Profile” in 3GPP specifications).

The request may indicate whether the NF is located inside (or outside) a RAN. Additionally or alternatively, the request may indicate whether the NF is mobile.

The request may comprise at least one of the parameters indicated above as being potentially provided/indicated as part of the InAccessNetworkInfo parameter. For example, the request may indicate at least one of: whether the registering NF is located inside a RAN, whether the registering NF is mobile, at least one performance characteristic of the access link to the NF, an access point name, geographic region(s) in which the registering NF may provide and/or receive a service, and/or a DU identifier.

At 14002′, the NRF 1402′ updates information stored in an NF profile corresponding to that of the update request in 14001′ in response to the signalling of 14001′.

At 14003′, the NRF 1402′ responds to the signalling of 14001′ to indicate that the NF profile has been updated. This indication may be sent in any of a plurality of different forms. For example, the indication may be sent as a defined 3GPP registration request for the network function 1401′ (such as the indication labelled “Nnrf_NFManagement_NFUpdate_Response” in 3GPP specifications). The indication may be sent using HTTP signalling (such as, for example, the indication labelled “200 OK (NFProfile)” in 3GPP specifications, or “4xx/5xx (ProblemDetails) when the update operation of 14002′ failed).

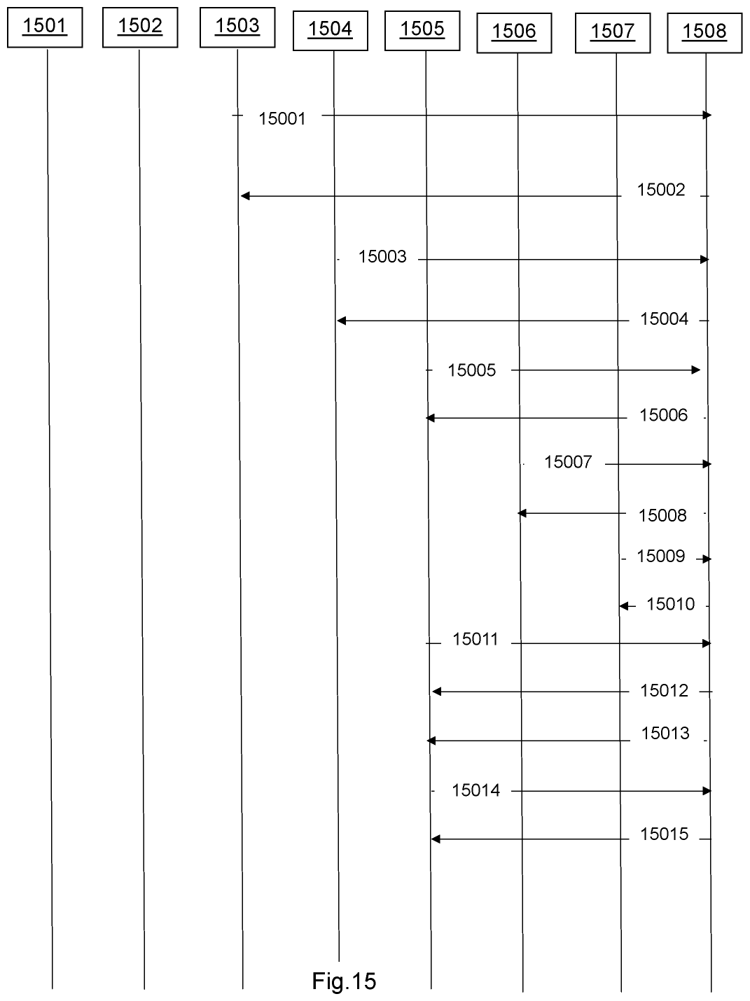

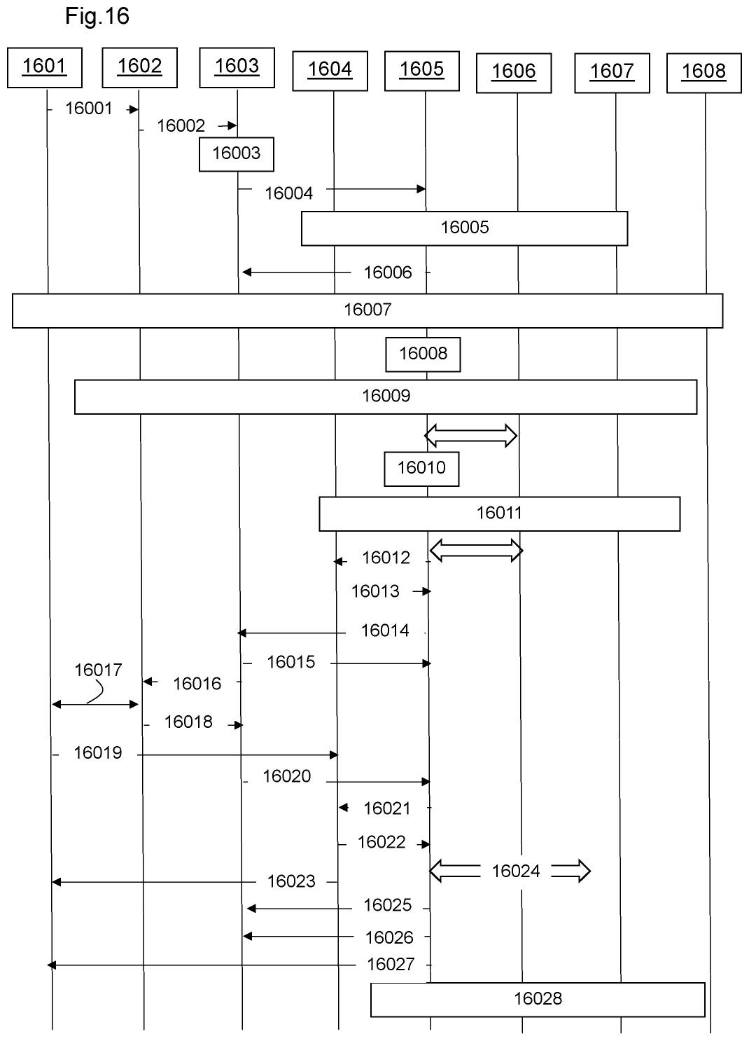

FIGS. 15 and 16 are example signalling diagrams illustrating potential signalling that may be performed using the new profile information. This example relates to a local service inside an IAB network comprising a local UPF is shown.

FIG. 15 is a signalling diagram that may be performed at, for example, startup of a network function.

FIG. 15 illustrates signalling between a UE 1501, a RAN 1502, an AMF 1503, a first (local) UPF 1504, an SMF 1505, a PCF 1506, a second UPF 1507, and an NRF 1508.

At 15001, the AMF 1503 sends a registration request for registering the AMF 1503 to NRF 1508. The registration request may have a format defined according to a specification. For example, the registration request may be as the registration request labelled as “Nnrf_NFManagement_NFRegister_Request” in 3GPP specifications.

At 15002, the NRF 1508 responds to the registration request of 15001 to indicate that the NRF has registered the AMF 1503. The registration request response may have a format defined according to a specification. For example, the registration request response may be as the registration request response labelled as “Nnrf_NFManagement_NFRegister_Response” in 3GPP specifications.

At 15003, the local UPF 1504 sends a registration request for registering the local UPF 1504 to NRF 1508. The registration request may have a format defined according to a specification. For example, the registration request may be as the registration request labelled as “Nnrf_NFManagement_NFRegister_Request” in 3GPP specifications. This registration request may additionally indicate that the local UPF 1504 is located inside a RAN. This registration request may additionally (or alternately) indicate that the local UPF 1504 is mobile.

At 15004, the NRF 1508 responds to the registration request of 15001 to indicate that the NRF has registered the local UPF 1504. The registration request response may have a format defined according to a specification. For example, the registration request response may be as the registration request response labelled as “Nnrf_NFManagement_NFRegister_Response” in 3GPP specifications.

At 15005, the SMF 1505 sends a registration request for registering the AMF SMF 1505 to NRF 1508. The registration request may have a format defined according to a specification. For example, the registration request may be as the registration as “Nnrf_NFManagement_NFRegister_Request” in 3GPP request labelled specifications.

At 15006 the NRF 1508 responds to the registration request of 15001 to indicate that the NRF has registered the AMF SMF 1505. The registration request response may have a format defined according to a specification. For example, the registration request response may be as the registration request response labelled as “Nnrf_NFManagement_NFRegister_Response” in 3GPP specifications.

At 15007, the PCF 1506 sends a registration request for registering the PCF 1506 to NRF 1508. The registration request may have a format defined according to a specification. For example, the registration request may be as the registration request labelled as “Nnrf_NFManagement_NFRegister_Request” in 3GPP specifications.

At 15008, the NRF 1508 responds to the registration request of 15001 to indicate that the NRF has registered the PCF 1506. The registration request response may have a format defined according to a specification. For example, the registration request response may be as the registration request response labelled as “Nnrf_NFManagement_NFRegister_Response” in 3GPP specifications.

At 15009, the second UPF 1507 sends a registration request for registering the second UPF 1507 to NRF 1508. The registration request may have a format defined according to a specification. For example, the registration request may be as the registration request labelled as “Nnrf_NFManagement_NFRegister_Request” in 3GPP specifications.

At 15010, the NRF 1508 responds to the registration request of 15001 to indicate that the NRF has registered the second UPF 1507. The registration request response may have a format defined according to a specification. For example, the registration request response may be as the registration request response labelled as “Nnrf_NFManagement_NFRegister_Response” in 3GPP specifications.

At 15011, the SMF 1505 sends a subscription request to the NRF 1509. The subscription request configures the NRF to alert the SMF 1505 when there has been a change in information stored about at least one of the first and second UPFs and/or configures the NRF to provide information on the first and second UPFs to the SMF 1505. The form of the subscription request may be defined in an operating specification. For example, the form of the subscription request may be in the form of “Nnrf_NFManagement_NF_StatusSubscribe (to information on UPFs).

At 15012, the NRF 1509 responds to the subscription request of 15011. The form of the response to the subscription request may be defined in an operating specification. For example, the form of the response to the subscription request may be in the form of “Nnrf_NFManagement_NF_StatusSubscribeResponse.

At 15013, the NRF 1509, in response to the subscription of 15011 being approved and the NRF determining that the subscribed-to event has occurred, sends information relating to the first and/or second UPFs to the SMF 1505. This message may indicate at least one profile of the first and/or second UPFs. This message may indicate that the first UPF is located in a RAN and/or that the first UPF is mobile.

As an alternative or in addition to the steps of 15011 to 15013, the steps of 15014 to 15015 may be performed to provide the SMF (or another network function) with information about requested network functions.

At 15014, the SMF 1505 sends a discovery request to the NRF 1509. The discovery request configures the NRF to provide information on the first and/or second UPFs to the SMF 1505. The form of the discovery request may be defined in an operating specification. For example, the form of the discovery request may be in the form of “Nnrf_NFDiscovery_Request”.

At 15015, the NRF 1509 responds to the discovery request of 1511. The form of the response to the discovery request may be defined in an operating specification. For example, the form of the response to the discovery request may be in the form of “Nnrf_NFDiscovery_RequestResponse”.

The signalling of 15015 may comprise information relating to the first and/or second UPFs to the SMF 1505. This message may indicate at least one profile of the first and/or second UPFs. This message may indicate that the first UPF is located in a RAN and/or that the first UPF is mobile.

FIG. 16 is a signalling diagram showing potential signalling that may be performed when a user requests a local service.

FIG. 16 illustrates signalling between a UE 1601, a RAN 1602, an AMF 1603, a first (local) UPF 1604, an SMF 1605, a PCF 1606, a second UPF 1607, and an NRF 1608. This signalling of FIG. 16 replicates at least some of the functions and signalling comprised in the service request procedure described in 3GPP TS 23.502. However, in contrast to the signalling described therein, the present FIG. 16 further comprises the local UPF 1604, which is included in the signalling.

At 16001, the UE 1601 sends a request to establish a session for a local service to RAN 1602. The request may be sent as a non-access stratum message. The request may request that a Protocol Data Unit session be established for providing the local service. The request may be a Radio Resource Control message.

At 16002, the RAN 1602 sends a request to establish a session for a service to the AMF 1603. The request may comprise an explicit indication that the requested service is a local service. The request may be a non-access stratum message. The request may be a next generation application protocol (NGAP) message. The request may request that a Protocol Data Unit session be established for providing the local service.

At 16003, the AMF 1603 selects an SMF for establishing the requested service. In the present case, the selected SMF is SMF 1605.

At 16004, the AMF 1603 signals, to the selected SMF 1605, a request to establish a session for providing a service to UE 1601. The request may explicitly indicate that the requested service is a local service. This explicit indication may be comprised within a modified version of an existing 3GPP message, such as, for example, the message currently labelled as a “Nsmf_PDUSession_CreateSMContextRequest” message.

At 16005, the SMF 1605 retrieves and/or updates subscription(s) for the UE with the UDM (not shown).

At 16006, the SMF 1605 responds to the signalling of 16004. This response may be an existing 3GPP message, such as, for example, the message currently labelled as a “Nsmf_PDUSession_CreateSMContext Response” message.

At 16007, the session is authenticated and/or authorized using protocols defined in the operating communication protocol.

At 16008, the SMF 1605 selects a PCF for the session being established. In the present case, the SMF 1605 selects PCF 1606.

At 16009, the SMF 1605 establishes and/or modifies a session management policy association for the session being established.

At 16010, the SMF 1605 selects a UPF for the session being established. In the present case, the selected UPF is the first UPF 1604.

At 16011, the SMF 1605 initiates a session management policy association in response to the UPF selection of 16010.

At 16012, the SMF 1605 sends a session establishment request and/or a session medication request to the first UPF 1604.

At 16013, the first UPF 1604 responds to the signalling of 16012 to indicate that the establishment and/or modification has been performed.

At 16014, the SMF 1605 signals the AMF 1603 for information associated with the UE's 1601 signalling over the N1 interface (i.e. the interface between the UE 1601 and the AMF 1603) and over the N2 interface (i.e. the interface between the UE 1601 and the RAN 1602).

At 16015, the AMF 1603 responds to the signalling of 16014 with an acknowledgement.

The steps 16016 to 16017 relate to the AMF obtaining the requested information of 16014.

At 16016, the AMF 1603 sends a session request for an N2 session to the RAN 1602.

At 16017, the RAN 1602 and the UE 1601 exchange signalling to allocate specific access network resources for setting up a session (e.g. a PDU session).

At 16018, the RAN 1602 responds to the signalling of 16015 with a session request response.

At 16019, the UE 1601 sends first uplink data to the first UPF 1604.

At 16020, the AMF 1603 sends to SMF 1605 a request to update the session management context. This request may be effected using a 3GPP signal, such as an Nsmf_PDUSession_UpdateSMContext request.

At 16021, the SMF 1605 sends a request to the first UPF 1604 to modify the session information on the interface between the SMF 1605 and the first UPF 1604 (i.e. on the N4 interface).

At 16022, the first UPF 1604 responds to the signalling of the 16021.

At 16023, the first UPF 1604 sends first downlink data to the UE 1601.

At 16024, the second UPF 1608 registers with the SMF 1605.

At 16025, the SMF 1605 signals an update session request to the AMF 1603. This update session request may be a 3GPP message, such as the Nsmf_PDUSession_UpdateSMContext Response.

At 16026, the SMF 1605 signals a session management status notification to the AMF 1603. This notification may be a 3GPP message, such as the Nsmf_PDUSession_SMContextStatusNotify.

At 16027, the SMF 1605 sends an address configuration (e.g. an IPV6 address configuration) to the first UPF 1604, which passes it to the UE 1601. The address configuration may be usable by the UE 1601 for generating addresses to be used for communication with local UPFs, such as the first UPF 1604.

At 16028, the SMF 1605 initiates a session management policy association.

During Topology Adaptation procedures (i.e. procedures that autonomously reconfigure the backhaul network under circumstances such as blockage or local congestion without discontinuing services for UEs), certain parameters may change. Current examples of those parameters that may change include accessLinkCharacteristics, access point/gNB name, and/or gNB-DU identifier. Such changes may be reported from an NF to the NRF in a profile update procedure.

A differentiation can be made between Intra-CU topology adaptation and Inter-CU topology adaptation. During an Intra-CU topology adaptation procedure, the IAB-donor-DU for the migrating IAB-node changes. In contrast, during an Inter-CU topology adaptation procedure, the IAB-donor-CU for the migrating IAB-node changes. In such an Inter-CU topology adaptation, the gNB changes and such a change may be reported by the impacted NF to the NRF.

The presently described techniques may also be applied when the Service Based Architecture is applied to the Radio Access Network. The Service Based RAN can be a corner-stone of a 6G-relevant architecture. In such an architecture, many NFs are likely to be placed inside relay nodes and such information (NF be behind a radio link, mobility) may be reported to the NRF.

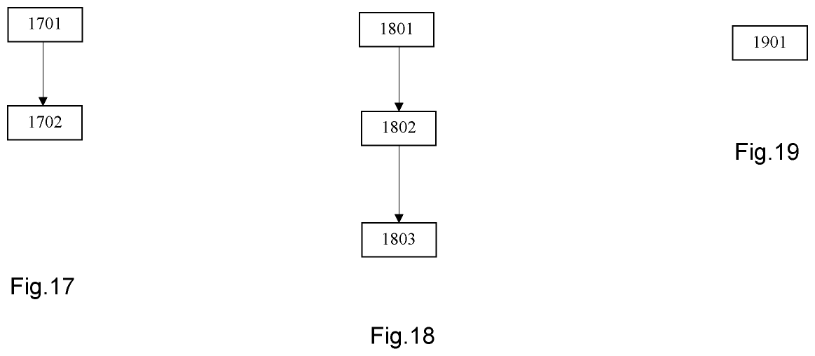

FIGS. 17 to 19 illustrate some of the general signalling that may be performed in view of the above-provided examples and the present disclosure.

FIG. 17 illustrates potential operations that may be performed by an apparatus for a network repository function. The network repository function may perform at least one of the functions described above in respect of the network repository functions.

At 1701, the apparatus receives, from a first network function, a first indication of whether the first network function is located in a radio access network.

The first indication may be signalled in at least one of a plurality of different ways and/or forms. For example, the first indication may be signalled with a third indication of whether the first network function is mobile. As another example, the first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services

The first indication may be stored as part of profile information for the first network function. As a more specific example, this first indication may be stored as described above in relation to Table 2.

The first network function may be, for example, a user plane function, such as the user plane function described below in relation to FIG. 19.

At 1702. in response to receiving a request for information about the first network function from a second network function, signalling to the second network function a second indication of whether the first network function is located in the radio access network.

The second network function may be, for example, a network function such as a session management function, and/or an access and mobility function. The second network function may be as described below in relation to FIG. 18.

The request for information may comprise a discovery request for a network function that is local to a service consumer. The network function may be considered local to the service consumer if they are comprised within the same radio access network part (e.g. within a domain of the radio access network part)

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

FIG. 18 illustrates potential operations that may be performed in relation to an apparatus for a second network function. The second network function may be, for example, an NF service consumer. The second network function may be, for example, a network function such as a session management function, and/or an access and mobility function. The second network function may interact with the network repository function of FIG. 17.

At 1801, the apparatus signals, to a network repository function, a request for information about a first network function. The first network function may be, for example, a user plane function. The first network function may be as described below in relation to FIG. 19.

The request for information may comprise a discovery request for a network function that is local to a service consumer. The network function may be considered local to the service consumer if they are comprised within the same radio access network part (e.g. within a domain of the radio access network part)

At 1802, in response to said signalling, the apparatus receives, from the network repository function, a second indication of whether the first network function is located in the radio access network.

At 1803, the apparatus signals, to the first network function, a request for service in response to the second indication.

The second indication may be signalled with a fourth indication of whether the first network function is mobile.

The second indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

The apparatus may signal a request to the first network function to associate with the first network function. This request may be sent prior to any session establishment for a service to be provided.

FIG. 19 illustrates potential operations that may be performed by an apparatus for a first network function. The first network function may be, for example, a user plane function. The first network function may interact with the network repository function described above in relation to FIG. 17.

At 1901, the apparatus signals, to a network repository function, a first indication of whether the first network function is located in a radio access network.

The first indication may be signalled in at least one of a plurality of different ways and/or forms. For example, the first indication may be signalled with a third indication of whether the first network function is mobile. As another example, the first indication may be signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services

The apparatus may receive, from the second network function located in the radio access network, a request to associate with the first network function. This request may be sent prior to any session establishment for a service to be provided.

The apparatus may receive, from a second network function located in the radio access network, a request to perform at least one function of the first network function subsequent to signalling the first indication. The second network function may be a network function as described above in relation to FIG. 18. The second network function may be, for example, a session management function and/or an access and mobility function.

As described above, the NF profile hosted in the NRF comprises information indicating whether an NF is located in the RAN (e.g. inside an IAB-node). Such information may then be used for new services as discussed in the framework for 3GPP Release 18, e.g. for providing local services in an IAB network. Such local services drastically remove the load on the radio links towards the Donor-gNB as the local traffic is handled/offloaded locally in the IAB-Node hosting the local UPF.

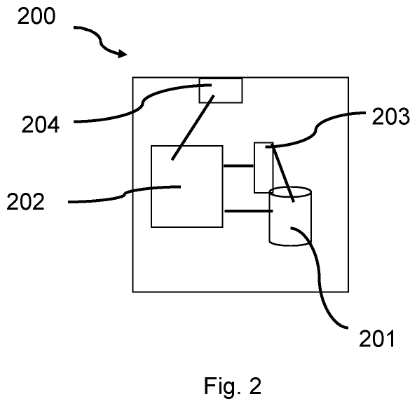

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

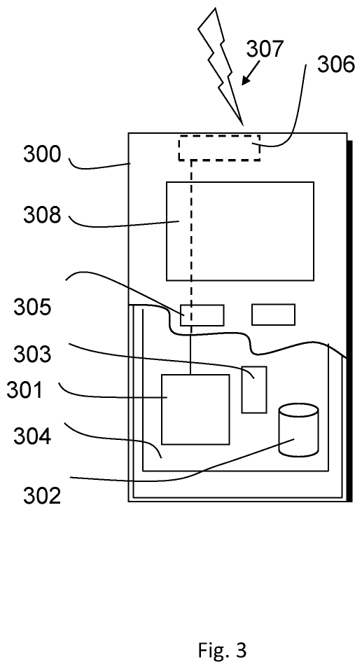

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

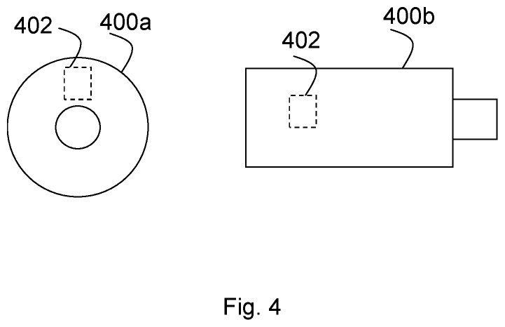

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 17, and/or FIG. 18, and/or FIG. 19.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 17, and/or FIG. 18, and/or FIG. 19, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

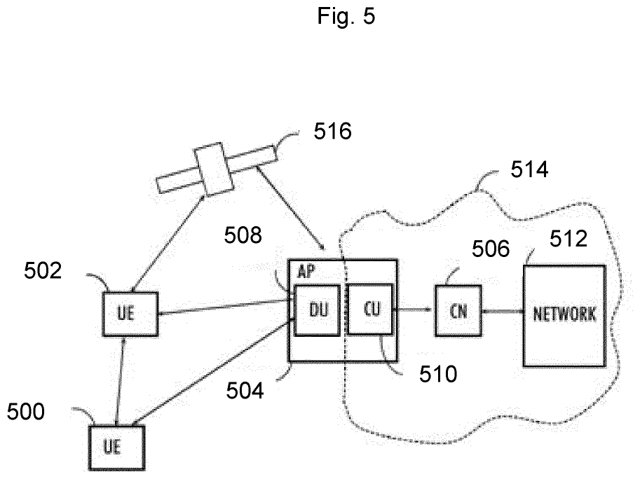

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support sidelink communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g)NodeB serving devices in a cell. In one example, the node 504 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 506 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 5). A HNB Gateway (HNB-GW), which is typically installed within an operator's network may aggregate traffic from a large number of HNBs back to a core network.

1) An apparatus for a network repository function, the apparatus comprising:
at least one processor; and
at least one memory comprising code that, when executed by the at least one processor, causes the apparatus to:
receive, from a first network function, a first indication of whether the first network function is located in a radio access network; and
in response to receiving a request for information about the first network function from a second network function, signalling to the second network function a second indication of whether the first network function is located in the radio access network.

2) An apparatus as claimed in claim 1, wherein the first indication is signalled with a third indication of whether the first network function is mobile.

3) An apparatus as claimed in any preceding claim, wherein the first indication is signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

4) An apparatus for a second network function, the apparatus comprising:
at least one processor; and
at least one memory comprising code that, when executed by the at least one processor, causes the apparatus to:
signal, to a network repository function, a request for information about a first network function;
in response to said signalling, receiving, from the network repository function, a second indication of whether the first network function is located in the radio access network; and
signal, to the first network function, a request for service in response to the second indication.

5) An apparatus as claimed in any preceding claim, wherein the second indication is signalled with a fourth indication of whether the first network function is mobile.

6) An apparatus as claimed in any preceding claim, wherein the second indication is signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

7) An apparatus as claimed in any preceding claim, wherein the request for information comprises a discovery request for a network function that is local to a service consumer.

8) An apparatus for a first network function, the apparatus comprising:
at least one processor; and
at least one memory comprising code that, when executed by the at least one processor, causes the apparatus to:
signal, to a network repository function, a first indication of whether the first network function is located in a radio access network.

9) An apparatus as claimed in claim 8, wherein the first indication is signalled with a third indication of whether the first network function is mobile.

10) An apparatus as claimed in any of claims 8 to 9, wherein the first indication is signalled with at least one of: a property of a radio link in the radio access network through which the first network function is reachable, an indication of a radio access network node in which the first network function is located, an indication of a path of network node hops for signalling the first network function, and/or an indication of an area to which the first network function is able to provide services.

11) A method for an apparatus for a network repository function, the method comprising:
receiving, from a first network function, a first indication of whether the first network function is located in a radio access network; and
in response to receiving a request for information about the first network function from a second network function, signalling to the second network function a second indication of whether the first network function is located in the radio access network.

12) A method for an apparatus for a second network function, the method comprising:
signalling, to a network repository function, a request for information about a first network function;
in response to said signalling, receiving, from the network repository function, a second indication of whether the first network function is located in the radio access network; and
signal, to the first network function, a request for service in response to the second indication.

13) A method for an apparatus for a first network function, the method comprising:
signalling, to a network repository function, a first indication of whether the first network function is located in a radio access network.

14) A computer program product that, when run on an apparatus for a network repository function, causes the apparatus to perform:
receiving, from a first network function, a first indication of whether the first network function is located in a radio access network; and
in response to receiving a request for information about the first network function from a second network function, signalling to the second network function a second indication of whether the first network function is located in the radio access network.

15) A computer program product that, when run on an apparatus for a second network function, causes the apparatus to perform:
signalling, to a network repository function, a request for information about a first network function;
in response to said signalling, receiving, from the network repository function, a second indication of whether the first network function is located in the radio access network; and
signal, to the first network function, a request for service in response to the second indication.

16) A computer program product that, when run on an apparatus for a first network function, causes the apparatus to perform:
signalling, to a network repository function, a first indication of whether the first network function is located in a radio access network.
